(19) United States
(12) Patent Application Publication
(10) Pub. No.: US 2013/0221268 A1
(43) Pub. Date: Aug. 29, 2013

(54) THERMALLY-CONDUCTIVE PASTE

(71) Applicants: Chien-Min SUNG, New Taipei City (TW); I-Chiao Lin, Taipei City (TW); Hung-Cheng Lin, New Taipei City (TW)

(72) Inventors: Chien-Min SUNG, New Taipei City (TW); I-Chiao Lin, Taipei City (TW); Hung-Cheng Lin, New Taipei City (TW)

(21) Appl. No.: 13/483,942

(22) Filed: May 30, 2012

(30) Foreign Application Priority Data
Feb. 29, 2012 (TW) 101106474

(51) Int. Cl. C09K 5/00

(52) U.S. Cl. 252/78.3; 252/71; 252/73; 252/77

(57) ABSTRACT

A thermally-conductive paste comprises a carrier, at least one graphene platelet, and a plurality of packing materials. The graphene platelets and the packing materials are dispersed in the carrier. At least a portion of the packing materials contact the surface of the graphene platelet. The graphene platelet has a very high thermal conductivity coefficient and a characteristic 2D structure and thus can provide continuous and long-distance thermal conduction paths for the thermally-conductive paste. Thereby is greatly improved the thermal conduction performance of the thermally-conductive paste.

### FIELD OF THE INVENTION

The present invention relates to a thermally-conductive paste, particularly to a thermally-conductive paste containing graphene platelets.

### BACKGROUND OF THE INVENTION

Thermal conduction is a critical problem in the major industrial products, such as the matured computer-related products, the emerging LED illuminators, and the highly-concerned environmental friendly solar cells. Normally, a high thermal conductivity material is placed close to or directly contacted to a heat source to fast carry away heat energy.

Thermally-conductive materials may be categorized according to the phases into bulk materials and fluid materials. Bulk materials are superior in thermal conductivity but inferior in formability, i.e. they are harder to integrate with the finished electronic elements. For example, a bulk material is integrated with electronic elements via sintering a composite powder of the bulk material on the surface of the electronic elements at a temperature of several hundred degree Celsius or even over one thousand degree Celsius, in which electronic elements are unlikely to endure. Contrarily, fluid materials are superior in formability but inferior to bulk materials in thermal conductivity.

As to thermally-conductive fluid materials, a U.S. Pat. Pub. No. US2010/0022423 discloses a nanometric-diamond thermally-conductive paste, which comprises a nanometric diamond powder, a thermally-conductive powder and a matrix material. The nanometric diamond powder has a ratio of 5-30 vol %. The thermally-conductive powder has a ratio of 40-90 vol %. The matrix material has a ratio of 5-30 vol %. The thermally-conductive powder may be a metal powder, a metal oxide powder, a carbide powder, or a silicide powder, such as a powder of copper, aluminum, nickel, aluminum oxide, zinc oxide, titanium dioxide, graphite, silicon carbide, aluminum carbide, or silicon dioxide. The matrix material is selected from a group consisting of polyvinyl acetate, polyethylene, acrylate, polypropylene (PP), epoxy resin, polyformaldehyde, polyvinyl alcohol (PVA), olefin resin, silicone oil, glycerin, olive oil, paraffin oil, and stearic acid.

A U.S. Pat. Pub. No. US2011/0039738 discloses a thermally-conductive silicon composite, which comprises two organopolysiloxanes and a thermally-conductive packing material. The thermally-conductive packing material may be a metal powder or a metal oxide powder, such as a powder of silver, gold, copper, aluminum, aluminum oxide, zinc oxide, or aluminum nitride. The silicon composite has a thermal conductivity coefficient of about 4.2-8.5 W/mK. U.S. Pat. No. 6,265,471 and Pub. No. US2007/0256783 discloses a thermally-conductive adhesive, which comprises an organic resin, a fugitive fluid, and an inorganic packing material. The organic resin may be a thermosetting resin or a thermoplastic resin. The inorganic packing material is in form of platelets or spheroids, and preferably made of silver. The fugitive fluid is used to increase the dispersity of the adhesive. The adhesive has a thermal conductivity coefficient higher than 40 W/mK.

The abovementioned prior arts could improve the thermal conductivity of thermally-conductive fluid materials to some extent. However, the industry demands higher and higher performance of thermally-conductive materials because electronic elements are being continuously evolved to achieve high reliability, high stability, high performance, and high slimness. Therefore, the prior arts still have room to improve.

### SUMMARY OF THE INVENTION

The primary objective of the present invention is to solve the problem of insufficient thermal conductivity of the conventional thermally-conductive paste.

To realize the abovementioned objective, the present invention proposes a thermally-conductive paste, which comprises a carrier, at least one graphene platelet dispersed in the carrier, a plurality of packing materials dispersed in the carrier, wherein at least a portion of the packing materials contact the surface of the graphene platelet.

In one embodiment, the packing materials are made of a material selected from a group consisting of diamond, hexagonal boron nitride, cubic boron nitride, aluminum nitride, aluminum oxide, silicon dioxide, and silicon carbide.

In one embodiment, the packing materials are made of a material selected from a group consisting of silver, gold, copper, and aluminum.

In one embodiment, the carrier is selected from a group consisting of silicone oil, epoxy resin, and benzocyclobutene.

In one embodiment, the thermally-conductive paste of the present invention further comprises a coupling agent mixed with the carrier. The coupling agent is selected from a group consisting of a mixture of a vinyl silane and an amino silane, oleyl alcohol polyethylene glycol ether, oleyl alcohol ethoxylated, octyl phenol ethoxylated(9.4), polyethylene glycol, 2-butanone, acetonitrile, 4-methyl-2-pentanone, acetone, and N,N-dimethylformamide (DMF).

In one embodiment, the packing materials are in form of powder, lumps, or scraps.

The thermally-conductive paste of the present invention outperforms the prior arts in that

1. Graphene has an ultra high thermal conductivity coefficient, higher than diamond and carbon nanotubes, which makes the thermally-conductive paste of the present invention have a thermal conductivity coefficient obviously higher than the existing thermally-conductive fluid materials.
2. In the conventional thermally-conductive pastes, thermally-conductive particles are mixed with resin and separated by resin. Thus, there are many phase boundaries between particles and resin within a given distance or in a given space. Further, the resin has poor thermal conductivity. Thus, the conventional thermally-conductive paste cannot have a higher thermal conductivity coefficient. Contrarily, the 2D graphene platelets foam continuous network in the thermally-conductive paste of the present invention. Therefore, the thermally-conductive paste of the present invention has fewer phase boundaries and higher thermal conduction performance.
3. The high electric conductivity graphene platelets are mixed with appropriate packing materials made of silver, gold or copper. Therefore, the thermally-conductive paste of the present invention can function as a high thermal conduction fluid material and a high electric conduction fluid material at the same time.

### DETAILED DESCRIPTION OF THE PREFERRED EMBODIMENTS

The present invention discloses a thermally-conductive paste applied to any heat source emitting heat energy, including electronic elements (such as semiconductors, transistors, IC, and PCB) and light-emitting elements (such as LED and high power gas discharge lamps). In addition to heat radiation, the thermally-conductive paste of the present invention can also apply to heat transference.

The thermally-conductive paste of the present invention comprises a carrier, at least one graphene platelet and a plurality of packing materials. The carrier is selected from a group consisting of silicone oil, epoxy resin, benzocyclobutene, and mixtures thereof. The carrier is a fluid having a given viscosity at the ambient temperature and providing fluidity for the thermally-conductive paste. The packing materials are particles made of a metallic material, a ceramic material, or a composite material, which can conduct heat. The metallic particles are preferably made of silver, gold, copper, aluminum, or a composite material thereof. The ceramic particles are preferably made of diamond, hexagonal boron nitride, cubic boron nitride, aluminum nitride, aluminum oxide, or silicon carbide. At least a portion of the packing materials contact the surface of the graphene platelet. Thus, heat is fast conducted along the graphene platelet. In the present invention, the graphene platelets may be made of single-atom-thick graphene sheets or multi-atom-thick graphene sheets.

The packing materials are in form of powder, lumps, or scraps. In the present invention, powder and lump are referred to particle-like objects in the macroscopic view. Powder is distinguished from lumps according to the particle sizes thereof. Lump has a particle size greater than powder. Powder may have a particle size of microns or nanometers. In the microscopic view, either of powder and lump may have different appearances, depending on the fabrication methods thereof. For example, particles of powder and lumps, which are fabricated in a gas atomization method, have a spheroidal appearance; particles of powder and lumps, which are fabricated in a water atomization method, have an irregular appearance. In the present invention, scraps are in form of plate-like chips having a size ranging from nanometers to microns. In practical application, the packing materials of the thermally-conductive paste may be in form of identical-size particles or different-size particles.

In fabrication, the packing materials and the graphene platelets are added into the carrier, and then they are mixed with a dispersing device or an agitating device, such as the three roll mill produced by EXAKT. Alternatively, the packing materials and the graphene platelets are mixed in a dry or wet mixing method firstly, and then the mixture is added into the carrier. The fabrication parameters (such as the mixing time and the mixing temperature) are adjusted according to the properties and ratios of the carrier, the packing materials and the graphene platelets, which is a matured technology and will not repeat herein.

In order to increase the dispersity of the packing materials in the carrier, a coupling agent is added into the thermally-conductive paste. The coupling agent is selected from a group consisting of a mixture of a vinyl silane and an amino silane, oleyl alcohol polyethylene glycol ether, oleyl alcohol ethoxylated, octyl phenol ethoxylated(9.4), polyethylene glycol, 2-butanone, acetonitrile, 4-methyl-2-pentanone,acetone, and N,N-dimethylformamide (DMF). Preferably, the coupling agent is mixed with the packing materials beforehand to increase the wettability of the packing materials. Further, an ultrasonic device may be used to make the packing materials separated from each other by appropriate distance in the carrier. In other words, it is preferred that the packing materials are uniformly distributed in the carrier.

The present invention prevents the packing materials from aggregation as much as possible, especially when the packing materials have a small particle size and higher cohesion force. When the packing materials are in form of powder or lumps and have a spheroidal appearance, it is preferred that the packing materials are dispersed in the carrier in a point-to-point contact state with the centers thereof almost equidistant. When the packing materials are in form of scraps and have a plate-like appearance, it is preferred that the packing materials are dispersed in the carrier in a face-to-face contact state so as to increase the contact area of the packing materials.

In conclusion, the thermally-conductive paste of the present invention is characterized in containing graphene platelets and thermally-conductive packing materials. As the graphene platelets have a very high thermal conductivity coefficient (over 4500 W/mK), they can promote the thermal conduction performance of the thermally-conductive paste. As the graphene platelets have high strength and high flexibility, they can keep the planar structure after they have been uniformly mixed with the carrier. The continuous 2D structure of the graphene platelets can solve the problem that too many phase boundaries decrease the thermal conductivity coefficient in the conventional technology. Therefore, the graphene platelets can still present the original thermal conduction property thereof in the thermally-conductive paste. Further, the present invention adopts the high electric conductivity packing materials to cooperate with the graphene platelets having a very high electric conductivity. Therefore, the thermally-conductive paste of the present invention can function as a high thermal conductivity fluid material and a high electric conductivity fluid material at the same time. Hence, the present invention possesses utility, novelty and non-obviousness and meets the condition for a patent. Thus, the Inventors file the application for a patent. It is appreciated if the patent is approved fast.

The present invention has been described in detail with the embodiments. However, the embodiments are only to exemplify the present invention. They are not intended to limit the scope of the present invention. Any equivalent modification or variation according to the spirit of the present invention is to be also included with the scope of the present invention.

What is claimed is:

1. A thermally-conductive paste, comprising:
a carrier;
at least one graphene platelet dispersed in the carrier; and
a plurality of packing materials dispersed in the carrier, wherein at least a portion of the packing materials contact a surface of the graphene platelet.

2. The thermally-conductive paste according to claim 1, wherein the packing materials are made of a material selected from a group consisting of diamond, hexagonal boron nitride, cubic boron nitride, aluminum nitride, aluminum oxide, and silicon carbide.

3. The thermally-conductive paste according to claim 1, wherein the packing materials are made of a material selected from a group consisting of silver, gold, copper, and aluminum.

4. The thermally-conductive paste according to claim 1, wherein the carrier is selected from a group consisting of silicone oil, epoxy resin, and benzocyclobutene.

5. The thermally-conductive paste according to claim 1 further comprising a coupling agent mixed with the carrier.

6. The thermally-conductive paste according to claim 5, wherein the coupling agent is selected from a group consisting of a mixture of a vinyl silane and an amino silane, oleyl alcohol polyethylene glycol ether, oleyl alcohol ethoxylated, octyl phenol ethoxylated(9.4), polyethylene glycol, 2-butanone, acetonitrile, 4-methyl-2-pentanone,acetone, and N,N-dimethylformamide (DMF).

7. The thermally-conductive paste according to claim 1, wherein the packing materials are in form of powder, lumps or scraps.
